(19) United States
(12) Patent Application Publication
(10) Pub. No.: US 2025/0162184 A1
(43) Pub. Date: May 22, 2025

(54) CUTTING APPARATUS FOR SEGMENTING A BLISTER PACK

(71) Applicant: tantum sana GmbH, Pfungstadt (DE)

(72) Inventors: Dirk BRUNNER, Munchen (DE); Wolfgang EYSSEN, Rodermark (DE); Peter FRÜHWEIN, Rodermark (DE)

(21) Appl. No.: 18/842,353

(22) PCT Filed: Feb. 16, 2023
(86) PCT No.: PCT/EP2023/053840

§ 371 Date: Aug. 28, 2024

(30) Foreign Application Priority Data
Feb. 28, 2022 (DE) 10 2022 104 668.0

(51) Int. Cl. B26D 1/06; B26D 7/00; B26D 7/22; B65B 61/06

(52) U.S. Cl. CPC B26D 1/065; B26D 7/0006; B26D 7/22; B65B 61/06

(57) ABSTRACT

A cutting apparatus for segmenting a tube blister pack, comprising a blade which can be moved by means of a motor against an abutment, wherein the tube blister pack can be guided between the abutment and the blade, wherein the blade is held in a cutting unit comprising a blade holder, which can be moved back-and-forth by means of a motor, and a blade guide which is provided with a cut-out for the blade to pass through and is coupled to the blade holder, wherein the blade holder and the blade guide are coupled to one another by means of at least one resilient intermediate piece.

### RELATED APPLICATIONS

This application is a US national phase application which claims the benefit of priority under Article 8 PCT of PCT Application No. PCT/EP2023/053840, filed Feb. 16, 2023, which claims priority to DE 10 2022 104 668.0, filed Feb. 28, 2022, the contents of which are incorporated herein by reference in their entireties.

### BACKGROUND OF THE INVENTION

It is known to provide patient-specific blister packings of polymedications in order to make it easier for patients to take the respective medication composition. DE 10 2019 134 447 A1 discloses a device for dispensing medication compositions in which the polymedications are arranged in a tubular blister.

### SUMMARY OF THE INVENTION

The task of the invention is to provide a cutting apparatus for segmenting a blister pack which is constructionally simple and functionally reliable.

The invention results from the features of claim 1. Advantageous further developments and configurations are the subject of the dependent claims. Further features, possible applications and advantages of the invention are shown in the description hereinafter, as well as in the elucidation of configuration examples of the invention, which are represented in the figures.

The task is solved according to claim 1 in that, in a cutting apparatus with a blade which can be moved by means of a motor against an abutment, wherein the blister pack can be guided between the abutment and the blade, wherein the blade is held in a cutting unit comprising a blade holder, which can be moved back-and-forth by means of a motor, and a blade guide which is provided with a cut-out for the blade to pass through and is coupled to the blade holder, wherein the blade holder and the blade guide are coupled to one another by means of at least one resilient intermediate piece.

The invention enables very simple actuation by means of a single drive device which produces a back-and-forth or alternatively up-and-down movement, while at the same time ensuring that the blade is guided in a protected manner until just prior to the actual cutting operation, thereby effectively preventing injury to the user. The blade holder and the blade guide surrounding the knife blade are kept at a distance by the resilient intermediate piece until the blade guide strikes against the abutment while clamping the blister pack. Subsequently, the motor-driven blade holder then presses further against the blade guide and thereby deforms the resilient intermediate piece, whereby the distance between the blade holder and blade guide is reduced, which leads the knife blade to be able to emerge from the blade guide and cut through the blister pack. During the return movement of the blade holder, the resilient intermediate piece is first reformed into its original shape, wherein the blade guide initially remains in abutment with the blister pack, however the knife blade is picked up again by the blade guide. Only subsequently does the blade guide lift off from the blister pack and thereby from the abutment and release the separated blister pack. In so doing, the blade edge is protected inside the blade guide so that an injury to the user is precluded. Finally, the blade holder and the blade guide, which is coupled to it by means of the resilient intermediate piece, are moved back to the home position away from the abutment.

The resilient intermediate piece is preferably configured as a spring, particularly as a coil spring. Alternatively, it can exhibit any other configuration. Preferably, spring steel or a highly resilient plastics material come into consideration as material.

According to an advantageous configuration of the invention, a cutting edge of the blade is arranged in the cut-out in the initial position of the cutting unit, wherein, moreover, when preforming a cutting operation, the cutting unit is movable from the initial position towards the abutment until the blade guide abuts against the abutment while fixing the blister pack and the blade holder is movable against the blade guide during resilient deformation of the intermediate pieces and, in a cutting setting, the blade edge emerges from the cut-out for performing the cutting operation.

According to another advantageous further development of the invention, the cutting apparatus comprises a releasable locking device, which is configured to prevent a movement of the blade holder relative to the blade guide, to impede the blade edge from emerging from the blade guide which is in a locking setting until shortly before the cutting setting and can then be moved into a release position. While compressing the intermediate piece, the locking device effectively prevents unintentional relative movement between the blade holder and the blade guide, for example, by objects such as the fingers of the user unintentionally getting into the gap between the blade guide and the abutment. This prevents that the knife blade can unintentionally exit from the blade guide.

According to another advantageous further development of the invention, the locking device comprises a link. A ratchet that can be tilted about a transverse axis is arranged on the blade guide, which at one end comprises a guide arm that rests against the link and at the other end comprises a locking arm. This arrangement ensures a structurally very simple and functionally reliable mode of operation of the locking device.

According to another advantageous further development of this configuration, the link comprises a locking section and a releasing section, wherein, in the locking section that starts from the initial position, the ratchet is held in the locked setting and, in the releasing section, a movement of the ratchet into the release setting can be effected, in which the blade edge emerges from the cut-out to perform the cutting operation.

According to another advantageous further development of the cutting apparatus, the contact surface of the blade guide facing the abutment is provided with a friction-enhancing coating. This prevents the tube blister pack from shifting during the cutting operation and thereby any suffering of the quality of the cut. According to another advantageous further development of the cutting apparatus, the contact surface of the abutment facing the blade guide is provided with a friction-enhancing coating for the same purpose.

According to another advantageous further development of the cutting apparatus, the drive unit comprises a current monitoring unit in order to return the cutting unit to the initial position if a current threshold value is exceeded. In this manner, an electronic, preferably second, safety device is provided in the event that an object, such as a finger of the user, is located in the gap between the blade guide and the abutment during the movement of the cutting unit, so that the cutting unit is then moved back to the initial position.

### BRIEF DESCRIPTION OF THE DRAWINGS

Further advantages, features and details can be found in the following description, in which a configuration example is described in detail with reference to the drawings. Identical, similar and/or functionally identical parts are marked with the same reference signs.

Wherein:

FIG. 1: shows a schematic representation of a tube blister pack;

FIG. 2: shows a perspective representation of a portion of a segmenting apparatus for blister packs;

FIG. 3: shows a perspective representation of a cutting apparatus;

FIG. 4: shows a perspective cross-sectional representation of the cutting apparatus of FIG. 3;

FIG. 5: shows a perspective representation of a locking device for the cutting apparatus in a locked setting;

FIG. 6: shows a perspective representation of the locking device of FIG. 5 in a release setting;

FIG. 7: shows a perspective representation of the locking device with representation of a slicing blade;

FIG. 8: shows a perspective cross-sectional representation of the cutting apparatus of FIG. 7.

### DETAILED DESCRIPTION OF THE INVENTION

The invention relates to a cutting apparatus for segmenting a blister pack, comprising a blade that can be moved by means of a motor against an abutment, wherein the blister pack can be guided between the abutment and the blade. The invention enables very simple actuation by means of a single drive device which produces a back-and-forth or up-and-down movement, while at the same time ensuring that the blade is guided in a protected manner until just prior to the actual cutting operation, thereby effectively preventing injury to the user.

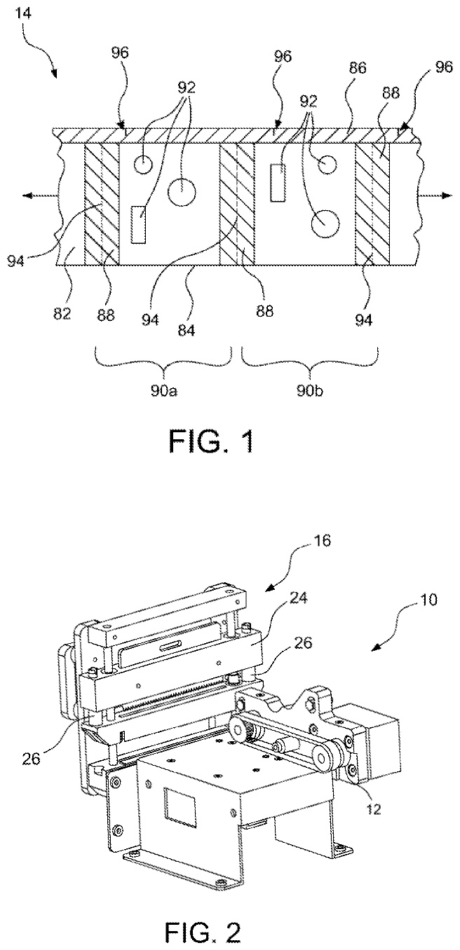

FIG. 1 schematically illustrates an example of a tube blister pack 14, which consists of a transparent plastic foil 82, which is folded at 84 and has a continuous longitudinal weld 86 on the opposite side. The tube blister pack 14 is subdivided by regularly spaced transverse welds 88 into individual closed pockets or blister packs 90a, 90b, in which tablets 92 are located. The same tablets 92 or individual tablet compositions for different times (morning, midday, evening) can be contained in all pockets 90a, 90b. A perforation 94 is preferably located in the center of each transverse weld 88 to enable manual separation of the end-side (first) pocket 90b from the rest of the tube blister pack 14. The tube blister pack 14 has an approximate width of 7-8 cm and adjacent transverse welds 88 are separated from one another by about 7-8 cm.

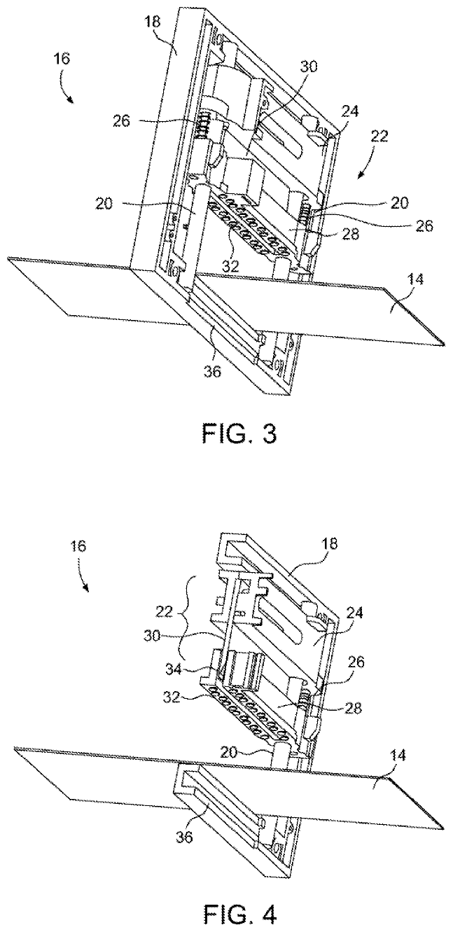

FIG. 2 through FIG. 4 show a part of a segmenting apparatus 10 for segmenting the tube blister packs 14 shown in FIG. 1, comprising a conveying apparatus 12 for conveying such a tube blister pack 14 to a cutting apparatus 16 in order to separate the tube blister pack 14 into individual blister packs 90 (FIG. 1). For this purpose, a blade splits the tube blister packs 14 as precisely as possible at the point of perforation 94.

The cutting apparatus 16 comprises a frame 18 on which guides 20 (configured as guide rods in the embodiment shown) for guiding a cutting unit 22 can be moved back-and-forth (or up-and-down in FIG. 2) in an oscillating manner. The cutting unit 22 consists substantially of a motor-driven blade holder 24 which is movable along the guides 20 and which (in the configuration shown) is coupled to a blade guide 28 by means of two elastic intermediate pieces 26, so that the blade guide is entrained during the motor-generated movement. A blade 30 is fixed to the blade holder 24, which blade passes through a cut-out 32 in the blade guide 28. The cut-out 32 can be a laterally closed or also open slit. The intermediate pieces 26 are dimensioned in such a way that the cutting edge 34 of the blade 30 is arranged inside the cut-out 32 in the absence of contact between the blade guide 28 and the abutment, and thereby injuries or damage caused by the blade edge 34 are effectively prevented. By means of the drive device that is not shown, which is operatively connected to the blade holder 24, the blade holder is moved in the direction of the blister pack band 14 and pushes the blade guide 28 in front of it until the blade guide, while fixed by the tube blister pack 14 strikes against an abutment 36, which in the configuration shown is a component of the frame 18. The drive device and the locking device are dimensioned in such a way that the drive device cannot overcome the locking device in the locked state. The blade holder 24 is pushed further by the drive device, whereas the blade guide 28, which presses against the abutment 36, cannot be entrained any further, so that the intermediate pieces 26 are pushed together and the distance between blade holder 24 and blade guide 28 is thus reduced. As a result, the blade edge 34 emerges from the cut-out 32 at the end of the blade holder 24 in a cutting setting and swaps into a cut-out or alternatively a gap in the abutment 36 while cutting through the tube blister pack 14. In this way, the end of the lifting movement of the cutting unit 22 is reached and the cutting unit then moves again upwards, driven by the motor, to the starting position as the intermediate pieces 26 are returned to their shape. The tube blister pack 14 is subsequently advanced by one blister pack by the conveying apparatus 12.

The intermediate pieces 26 can preferably be configured as springs, in particular spiral springs, or rubber-elastic elements. These can also comprise damping elements to prevent resonance. It is also possible to use only one intermediate piece 26 instead of two.

Insofar as the terms “top” and “bottom” are used in connection with the cutting apparatus 16 according to the invention, this refers to one possible arrangement. The cutting apparatus 16 can alternatively also be arranged below or to the side of the tube blister pack 14, so that the terminology would change.

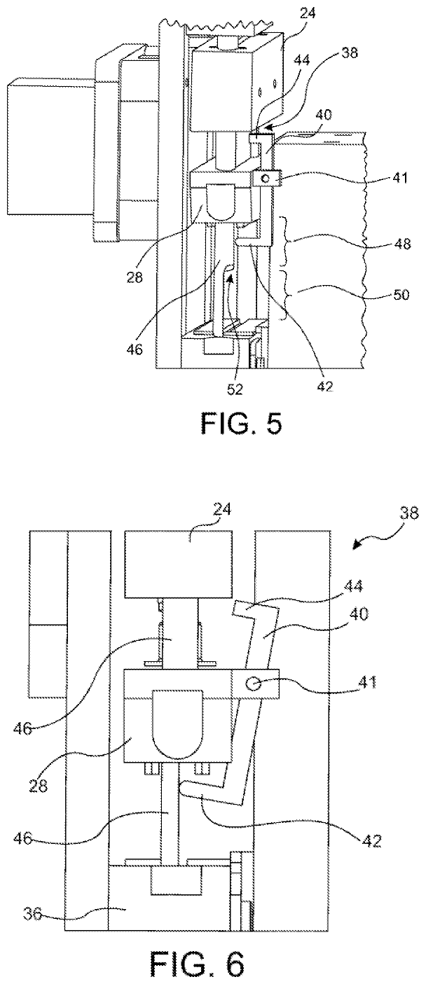

A preferred further development is illustrated in FIG. 5 and FIG. 6 which prevents the intermediate pieces 26 from being inadvertently pushed together before the start of the cutting operation, which is to say, before the blade holder 24 strikes the abutment 36. By way of example, a finger or any other part of a body of the user could end up between the blade holder 24 and the abutment 36 when the cutting unit 22 is in or near its upper end position. For this purpose, a locking device 38 is provided, which comprises a tiltable ratchet 40, which is arranged on the blade guide 28 so as to be tiltable or pivotable about a transverse axis 41. The ratchet 40 comprises a lower guide arm 42, which is pressed against a link 46 by spring means that are not shown, and an upper locking arm 44, which serves as a stop for the blade holder 24 when the ratchet 40 is in the locked setting illustrated in FIG. 4. In this locked setting, the locking arm 44 prevents the blade holder 24 and the blade guide 28 from approaching each other, so that the blade edge 34 inside the blade guide 28 cannot protrude from the cut-out 32 and cause injury or damage. The link 46 comprises two sections for this purpose, a locking section 48 and a releasing section 50, between which a transition point 52 is formed. The releasing section 50 allows the guide arm 42 to move and thereby-in the views of FIG. 4 and FIG. 5-a clockwise pivoting or tilting movement of the ratchet 40 about the transverse axis 41, from the locked setting shown in FIG. 5 to the release setting shown in FIG. 6. In so doing, the locking arm 44 moves out of the movement range of the blade holder 42, so that the blade holder 24 can now approach the blade guide 28 with elastic deformation of the intermediate pieces 26, whereby the blade edge 34 emerges from the cut-out 32 in order to perform the cutting operation of the tube blister pack 14. The transition point 52 is preferably selected in such a manner that the movement of the ratchet 40 into the release setting only takes place shortly before the blade guide 28 strikes the tube blister pack 14, so that there can no longer be any body parts in between. The link 46 can also be configured as part of one of the guides 20 for the cutting unit.

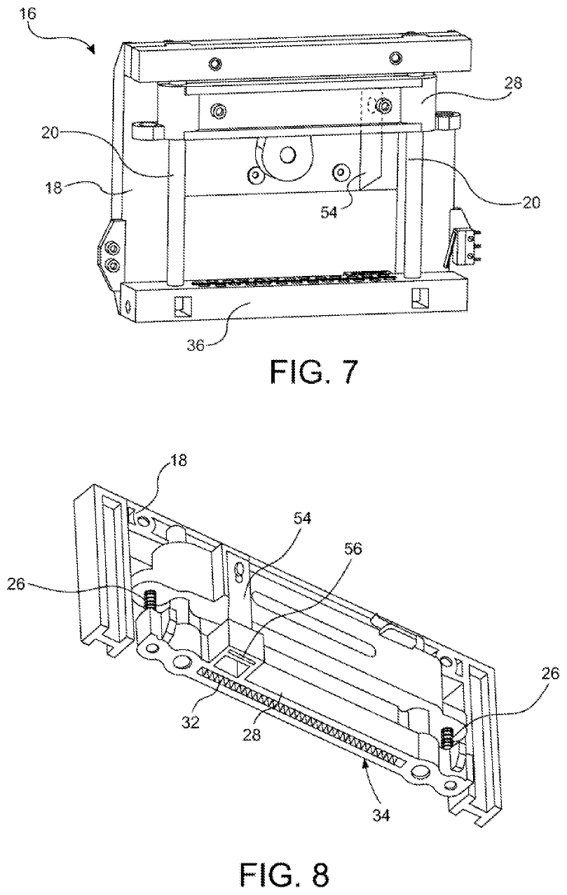

In FIG. 7 and FIG. 8, a slicing blade 54 is shown in two perspective views of the cutting apparatus 16, which slicing blade is arranged at a distance from the main blade 30 and passes through a slicing blade slit 56. The slicing blade 54 is arranged at a distance of approx. 1-2 cm from the main blade 30 and serves to form a slit 96 of 3-5 mm length in the longitudinal weld 86 in the tube blister pack 14, which only partially (40-60%) cuts through the longitudinal weld 86 and serves to more easily manually tear open an isolated blister pack 90b.

Even if the invention has been illustrated and elucidated in detail by preferred configuration examples, the invention is not limited by the disclosed examples and other variations may be derived by the person skilled in the art without departing from the scope of protection of the invention. It is therefore clear that a large number of possible variations exist. It is likewise clear that embodiments mentioned by way of example, actually only represent examples which are not to be understood in any way as limiting, for example, the scope of protection, the possible applications or the configuration of the invention. Rather, the preceding description and the description of the figures enable the person skilled in the art to implement the exemplary embodiments in concrete terms, wherein the person skilled in the art, knowing the disclosed inventive concept, can make a variety of changes, for example with regard to the function or the arrangement of individual elements mentioned in an exemplary embodiment, without leaving the scope of protection defined by the claims and their legal equivalents, such as further explanations in the description.

1. A cutting apparatus for segmenting a tube blister pack, comprising a blade that can be moved by means of motor against an abutment, wherein the tube blister pack can be guided between the abutment and the blade, characterized in that
the blade is held in a cutting unit comprising a blade holder, which can be moved back-and-forth by means of a motor, and a blade guide which is provided with a cut-out for the blade to pass through and is coupled to the blade holder, wherein the blade holder and blade guide are coupled to one another by means of at least one resilient intermediate piece.

2. The cutting apparatus according to claim 1, characterized in that a cutting edge of the blade is arranged in the cut-out in an initial position of the cutting unit, wherein, moreover, when performing a cutting operation, the cutting unit is movable from the initial position towards the abutment until the blade guide abuts against the abutment while fixing the tube blister pack and the blade holder is movable against the blade guide during resilient deformation of the intermediate pieces and, in a cutting setting, the blade edge emerges from the cut-out for performing the cutting operation.

3. The cutting apparatus according to claim 2, characterized in that the cutting apparatus comprises a releasable locking device in the direction of movement of the cutting apparatus, which is configured to prevent a movement of the blade holder relative to the blade guide, to impede the blade edge from emerging from the blade guide, wherein the locking device is in a locking setting until shortly before the cutting setting and can then be moved into a release setting.

4. The cutting apparatus according to claim 3, characterized in that the locking device comprises a link, and a ratchet, that can be tilted about a transverse axis, is arranged on the blade guide, which at one end comprises a guide arm that rests against the link and at the other end comprises a locking arm.

5. The cutting apparatus according to claim 4, characterized in that the link comprises a locking section and a releasing section, wherein, in the locking section that starts from the initial position, the ratchet is held in the locked setting and, in the releasing section, a movement of the ratchet into the release setting can be effected, in which the blade edge emerges from the cut-out to perform the cutting operation.

6. The cutting apparatus according to claim 1, characterized in that the cutting apparatus comprises a slicing blade for forming a slicing blade slit in the tube blister pack.

7. The cutting apparatus according to claim 6, characterized in that the slicing blade is mounted on the blade holder.

8. The cutting apparatus according to claim 7, characterized in that the blade guide comprises a second slit for the slicing blade to pass through.

9. The cutting apparatus according to claim 1, characterized in that the contact surface of the blade guide facing the abutment is provided with a friction-enhancing coating.

10. The cutting apparatus according to claim 1, characterized in that the contact surface of the abutment facing the blade guide is provided with a friction-enhancing coating.

11. The cutting apparatus according to claim 1, characterized in that the drive unit comprises a current monitoring unit in order to return the cutting unit to the initial position if a current threshold value is exceeded.

12. The cutting apparatus according to claim 2, characterized in that the cutting apparatus comprises a slicing blade for forming a slicing blade slit in the tube blister pack.

13. The cutting apparatus according to claim 3, characterized in that the cutting apparatus comprises a slicing blade for forming a slicing blade slit in the tube blister pack.

14. The cutting apparatus according to claim 4, characterized in that the cutting apparatus comprises a slicing blade for forming a slicing blade slit in the tube blister pack.

15. The cutting apparatus according to claim 5, characterized in that the cutting apparatus comprises a slicing blade for forming a slicing blade slit in the tube blister pack.

16. The cutting apparatus according to claim 2, characterized in that the contact surface of the blade guide facing the abutment is provided with a friction-enhancing coating.

17. The cutting apparatus according to claim 6, characterized in that the contact surface of the blade guide facing the abutment is provided with a friction-enhancing coating.

18. The cutting apparatus according to claim 2, characterized in that the contact surface of the abutment facing the blade guide is provided with a friction-enhancing coating.

19. The cutting apparatus according to claim 6, characterized in that the contact surface of the abutment facing the blade guide is provided with a friction-enhancing coating.

20. The cutting apparatus according to claim 9, characterized in that the contact surface of the abutment facing the blade guide is provided with a friction-enhancing coating.
